(19) United States
(12) Patent Application Publication
(10) Pub. No.: US 2018/0150242 A1
(43) Pub. Date: May 31, 2018

(54) CONTROLLER AND STORAGE DEVICE FOR EFFICIENT BUFFER ALLOCATION, AND OPERATING METHOD OF THE STORAGE DEVICE

(71) Applicant: SAMSUNG ELECTRONICS CO., LTD., Suwon-si (KR)

(72) Inventors: Hyun-ju YI, Hwaseong-si (KR); Hyun-soo BAE, Seoul (KR); Jung-pil LEE, Hwaseong-si (KR); Hyo-taek LEEM, Suwon-si (KR); Jong-min KIM, Seoul (KR); Ran-hee LEE, Uiwang-si (KR)

(73) Assignee: SAMSUNG ELECTRONICS CO., LTD., Suwon-si (KR)

(21) Appl. No.: 15/811,991

(22) Filed: Nov. 14, 2017

(30) Foreign Application Priority Data
Nov. 30, 2016 (KR) 10-2016-0162305

(51) Int. Cl. G06F 3/06; G06F 13/28

(52) U.S. Cl. CPC G06F 3/0616; G06F 3/0679; G06F 13/28; G06F 3/0659; G06F 3/061

(57) ABSTRACT

Disclosed are a controller and a storage device for efficient buffer allocation, and a method of operating the storage device. The storage device includes a non-volatile memory including a plurality of non-volatile memory cells, a buffer including a plurality of storage spaces to be allocated for a plurality of commands fetched from a host, and a storage controller connected to the non-volatile memory via a plurality of channels, the storage controller being configured to store status information corresponding to a workload of each of the plurality of channels and to allocate the buffer for the plurality of commands, the allocation being based on the status information.

### CROSS-REFERENCE TO RELATED APPLICATION

This application claims the priority from Korean Patent Application No. 10-2016-0162305, filed on Nov. 30, 2016, in the Korean Intellectual Property Office, the disclosure of which is incorporated herein by reference in its entirety.

### BACKGROUND

Methods and apparatuses consistent with example embodiments relate to a controller and, more particularly, to a controller and a storage device that provide efficient buffer allocation, and an operating method thereof.

As a semiconductor memory device, a non-volatile memory device includes memory cells for storing data in a non-volatile manner. A flash memory device, an example of the non-volatile memory device, is used in various types of storage devices such as a memory card and a solid state drive (SSD), and a storage device may be employed and used in various electronic systems such as a mobile phone, a digital camera, a personal digital assistant (PDA), a portable computer, and a stationary computer.

A storage device may store and read data based on requests of a host. The storage device may include a plurality of flash memory devices, and perform memory operations of the flash memory devices, e.g., data write and data read operations, via a plurality of channels. The storage device may include a storage element (e.g., a buffer) for temporarily storing data, and write data or read data may be temporarily stored in the buffer in the memory operations.

The memory operations may be performed per channel, and each individual channel may have a different operation status. For example, a plurality of memory operations may be on standby to be performed via certain channels. Thus, if the buffer is allocated for the memory operations via the certain channels, a long time may be taken until the buffer is de-allocated. As such, a lifetime for which allocation of the buffer is maintained may be increased, and usability of the buffer may be reduced.

### SUMMARY

One or more example embodiments provide a controller and a storage device for efficient buffer allocation, and an operating method of the storage device.

According to an aspect of an example embodiment, there is provided a storage device including: a non-volatile memory including a plurality of non-volatile memory cells; a buffer including a plurality of storage spaces configured to be allocated for a plurality of commands fetched from a host; and a storage controller connected to the non-volatile memory via a plurality of channels, the storage controller being configured to store status information corresponding to a workload of each of the plurality of channels and to allocate the buffer for the plurality of commands, the allocation being based on the status information.

According to an aspect of another example embodiment, there is provided a storage controller configured to control a non-volatile memory via a plurality of channels, the storage controller including: a central processing unit (CPU); a fetch circuit configured to fetch a plurality of commands from a host; a memory configured to store status information corresponding to a workload of each of the plurality of channels; a prediction and monitor block configured to predict channels of the plurality of channels to be mapped to the plurality of commands, and monitor statuses of the predicted channels based on the status information; and a buffer including a plurality of storage spaces to be allocated for the plurality of commands based on a result of monitoring.

According to an aspect of still another example embodiment, there is provided a method of operating a storage device, the storage device including a first queue corresponding to a first channel and a second queue corresponding to a second channel, the method including: sequentially fetching a first command and a second command from a host, the first channel being mapped to the first command and the second channel being mapped to the second command; monitoring statuses of the first channel and the second channel; and preferentially allocating a buffer for the second command based on a result of the monitoring indicating it is appropriate to queue the second command in the second queue.

According to an aspect of yet another example embodiment, there is provided a storage controller configured to control a non-volatile memory via a plurality of channels, the storage controller including: a buffer including a plurality of storage spaces to be allocated for commands received from a host; and a controller configured to monitor statuses of each of the plurality of channels, and allocate the buffer for a plurality of commands based on the statuses of each of the plurality of channels.

### BRIEF DESCRIPTION OF THE DRAWINGS

Example embodiments will be more clearly understood from the following detailed description taken in conjunction with the accompanying drawings in which:

FIG. 1 is a block diagram of an electronic system according to an example embodiment;

FIG. 2 is a block diagram of a storage device implemented as a solid state drive (SSD) according to an example embodiment;

FIG. 3 is a block diagram of a controller according to an example embodiment;

FIGS. 4A and 4B show information stored in a random-access memory (RAM) according to one or more example embodiments;

FIGS. 5A and 5B show lifetimes of a buffer in write and read operations of a non-volatile memory according to one or more example embodiments;

FIGS. 6 to 8 are flowcharts of operating methods of a storage device, according to one or more example embodiments;

FIG. 9 is a block diagram showing flow of a buffer allocation operation according to an example embodiment;

FIG. 10 shows an example of buffer lifetimes based on whether a buffer allocation scheme according to example embodiments is used;

FIG. 11 is a block diagram showing an example in which a buffer allocation operation according to example embodiments is implemented by software;

FIG. 12 is a flowchart of an operating method of a storage device, according to an example embodiment;

FIGS. 13A, 13B, 14A, 14B, 15A, 15B, 15C and 16 show various status information generation operations and a buffer allocation operations according to one or more example embodiments;

FIG. 17 is a flowchart of an operating method of a storage device, according to an example embodiment; and

FIG. 18 is a block diagram of an electronic system according to an example embodiment.

### DETAILED DESCRIPTION OF EXAMPLE EMBODIMENTS

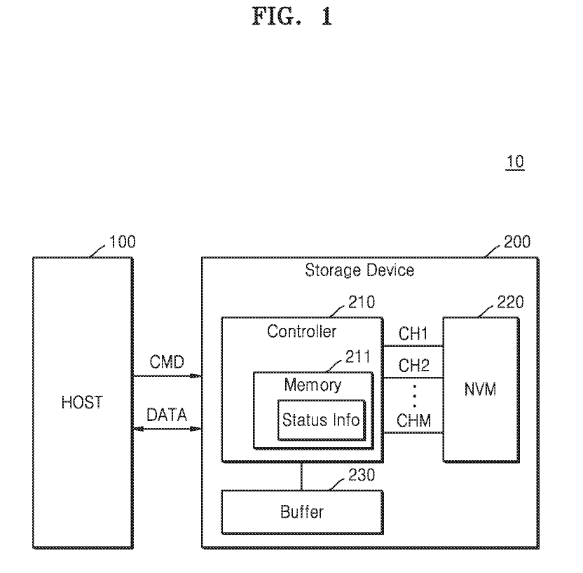

FIG. 1 is a block diagram of an electronic system 10 according to an example embodiment.

Referring to FIG. 1, the electronic system 10 according to an example embodiment includes a host 100 and a storage device 200. The storage device 200 may be a solid state drive (SSD). However, example embodiments are not limited thereto, and the storage device 200 may be implemented as various types of devices such as an embedded multimedia card (eMMC), a universal flash storage (UFS) card, a compact flash (CF) card, a secure digital (SD) card, a micro secure digital (Micro-SD) card, a mini secure digital (Mini-SD) card, an extreme digital (xD) card, and a memory stick.

The storage device 200 may communicate with the host 100 via various interfaces. The host 100 may request a data processing operation, e.g., a data read operation or a data write operation, of the storage device 200. In an example embodiment, the host 100 may be a central processing unit (CPU), a processor, a microprocessor, an application processor (AP), or the like. According to an example embodiment, the host 100 may be implemented as a system-on-a-chip (SoC).

For communication between the storage device 200 and the host 100, various interfaces such as an advanced technology attachment (ATA) interface, a serial ATA (SATA) interface, an external SATA (e-SATA) interface, a small computer small interface (SCSI), a serial attached SCSI (SAS) interface, a peripheral component interconnection (PCI) interface, a PCI express (PCI-E) interface, an IEEE 1394 interface, a universal serial bus (USB) interface, a secure digital (SD) card interface, a multimedia card (MMC) interface, an embedded multimedia card (eMMC) interface, and a compact flash (CF) card interface may be used.

The storage device 200 may include a non-volatile memory (NVM) 220 including a plurality of non-volatile memory cells. In an example embodiment, the non-volatile memory 220 may include a plurality of flash memory cells. For example, the flash memory cells may be NAND flash memory cells. However, example embodiments are not limited thereto, and the memory cells may be resistive memory cells such as resistive random-access memory (ReRAM) cells, phase-change RAM (PRAM) cells, or magnetic RAM (MRAM) cells.

In an example embodiment, the non-volatile memory 220 may be a three-dimensional (3D) memory array. The 3D memory array is monolithically generated in at least one physical level of memory cell arrays each having an active region provided on a silicon substrate, and a circuit related to operations of memory cells may be provided on or in the substrate. The term “monolithically” indicates that layers of each level of the array are stacked directly on layers of a lower level of the array. In an example embodiment, the 3D memory array includes vertical NAND strings, in each of which at least one memory cell is provided on another memory cell in a vertical direction. The at least one memory cell may include a charge trapping layer.

U.S. Pat. Nos. 7,679,133, 8,553,466, 8,654,587 and 8,559,235, and U.S. Patent Application Publication No. 2011/0233648, which are incorporated herein by reference, disclose proper configurations of a 3D memory array provided in a plurality of levels sharing word lines and/or bit lines.

The storage device 200 may further include a storage controller (hereinafter referred to as a controller) 210 for controlling memory operations of the non-volatile memory 220, e.g., data write or read operations. The storage device 200 may further include a buffer 230 for temporarily storing data in the data write and read operations. For example, the buffer 230 may be implemented as a volatile memory such as dynamic RAM (DRAM) or static RAM (SRAM). For example, the buffer 230 may include a write data buffer for temporarily storing write data, and a read data buffer for temporarily storing read data. Optionally, the buffer 230 may be included in the controller 210.

The controller 210 may control the memory operations of the non-volatile memory 220 via one or more channels CH1 to CHM. For example, the controller 210 may be connected to the non-volatile memory 220 via the M channels CH1 to CHM, and write or read data in or from the non-volatile memory 220. For example, the controller 210 may control the non-volatile memory 220 connected to different channels, in parallel.

According to an example embodiment, the non-volatile memory 220 may include a plurality of memory chips. The non-volatile memory 220 may include one or more memory chips corresponding to each of the M channels CH1 to CHM. Based on commands (or requests) from the host 100, the controller 210 may queue the commands for the M channels CH1 to CHM and transmit or receive data (Data) based on the commands to or from the non-volatile memory 220 via the M channels CH1 to CHM.

According to an example embodiment, the controller 210 may include a memory 211 for storing status information of the M channels CH1 to CHM (or status information of the non-volatile memory 220 corresponding to the M channels CH1 to CHM). According to an example embodiment, the memory 211 may be implemented as a volatile memory such as DRAM or SRAM. However, example embodiments are not limited thereto, and the memory 211 may be implemented as a non-volatile memory such as read-only memory (ROM), programmable ROM (PROM), erasable programmable ROM (EPROM), electrically erasable programmable ROM (EEPROM), phase-change RAM (PRAM), or flash memory.

Status information (Status Info) of the M channels CH1 to CHM may be stored in the memory 211. For example, the status information having one or more bits corresponding to each of the M channels CH1 to CHM may be stored in the form of a bitmap or a table. The status information may indicate whether allocation of the buffer 230 (or a storage space of the buffer 230) for the commands mapped to each channel is proper (or appropriate).

To set a value of the status information per channel, for example, a workload of each of the M channels CH1 to CHM may be determined. The workload may be determined using various schemes. For example, the workload may be determined based on the number of commands to be processed (or scheduled to be processed) via each channel. Alternatively, the non-volatile memory 220 corresponding to each of the M channels CH1 to CHM may perform or be scheduled to perform a background operation which requires a relatively long time, and the workload may be determined based on whether the background operation is performed.

The value of the status information may be set based on the determined workload. For example, the value of the status information may be set based on whether the determined workload is greater than a threshold value. For example, it may be determined whether the number of commands to be processed is greater than a certain number. Alternatively, it may be determined whether a time required for the commands or the background operation is greater than a certain reference time. That is, the status information may be generated using various schemes based on the determined workload.

According to an example embodiment, the status information of each of the M channels CH1 to CHM may be information including one or more bits. For example, when the status information has a value of two or more bits, the workload of each channel may be analyzed in various stages, and the status information may be set to a value indicating any one of the multiple stages, based on the result of analysis. Various background operations such as garbage collection, bad block management, read reclaim, and read replacement may require different times, and the status information may be set to a value indicating any one of the multiple stages, based on the type of the background operation.

The status information may indicate a processing timing and/or a processing completion timing of a command (CMD) newly mapped to each channel. For example, if a specific channel has a large workload, a command newly mapped to the specific channel may have a later processing timing, and thus have a late processing completion timing. Otherwise, if another specific channel has a small workload, a command newly mapped to the other specific channel may have a relatively early processing timing.

According to an example embodiment, the buffer 230 may be allocated to perform the memory operations (or command processing) in response to the commands fetched from the host 100, and the buffer 230 may be allocated based on the status information. For example, because the status information may indicate whether allocation of the buffer 230 to each of the M channels CH1 to CHM is appropriate, the buffer 230 may be preferentially allocated for the commands corresponding to a channel to which allocation of the buffer 230 is appropriate. That is, the commands for performing the memory operations via the M channels CH1 to CHM may be fetched, and the buffer 230 may be preferentially allocated for a command having an early processing timing and/or an early processing completion timing.

According to the afore-described example embodiment, a problem of reducing usability of the buffer 230 because the buffer 230 is allocated for a command mapped to a specific channel and the allocation state of the buffer 230 is maintained for a long time due to a large workload of the specific channel may be solved. For example, when the buffer 230 is allocated for a command at a timing when the command is fetched, if a processing timing of the command is late, the allocation state of the buffer 230 is unnecessarily maintained.

On the contrary, according to the afore-described example embodiment, because the buffer 230 is preferentially allocated for a command to be processed at an early timing and the buffer 230 is de-allocated after the command is completely processed, a time for which allocation of the buffer 230 is maintained (e.g., a lifetime) may be reduced. In addition, because the buffer 230 is allocated later for a command to be processed at a later timing, unnecessarily long allocation of the buffer 230 for the command may be prevented.

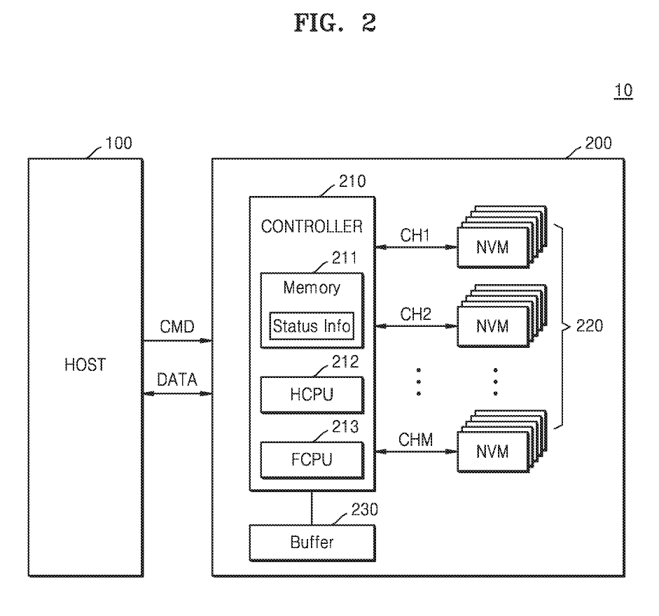

FIG. 2 is a block diagram of a storage device 200 implemented as an SSD according to an example embodiment.

Referring to FIG. 2, the storage device 200 may communicate with the host 100, and include the controller 210, the non-volatile memory 220, and the buffer 230. The controller 210 may further include the memory 211 for storing the status information according to the afore-described example embodiment, and one or more processing cores for controlling overall operations of the storage device 200. For example, as the one or more processing cores, FIG. 2 illustrates a host CPU (HCPU) 212 for performing operations related to interfacing with the host 100, and a flash CPU (FCPU) 213 for performing operations related to interfacing with the non-volatile memory 220. Although a single host CPU 212 and a single flash CPU 213 are illustrated in FIG. 2, example embodiments are not limited thereto. For example, multiple host CPUs and multiple flash CPUs may be included in the controller 210. The multiple host CPUs may perform the operations related to interfacing with the host 100 in parallel, and the multiple flash CPUs may perform the operations related to interfacing with the non-volatile memory 220 in parallel.

The controller 210 is connected to the non-volatile memory 220 via the M channels CH1 to CHM. Channel striping may be performed to evenly assign a plurality of commands from the host 100, to the M channels CH1 to CHM, and thus the commands may be evenly mapped to the M channels CH1 to CHM. The M channels CH1 to CHM may have different numbers of queued commands (or not-completely-processed commands) based on a command processing status of the non-volatile memory 220 via each channel, and thus have different workloads.

According to the afore-described example embodiment, command processing statuses of the M channels CH1 to CHM may be determined, and the status information based on the result of determination may be stored in the memory 211. In addition, the host CPU 212 or the flash CPU 213 may check the status information stored in the memory 211, and control allocation of the buffer 230, based on the checked status information. For example, the host CPU 212 or the flash CPU 213 may preferentially allocate the buffer 230 for a command having an early processing timing (or an early processing completion timing), based on the status information.

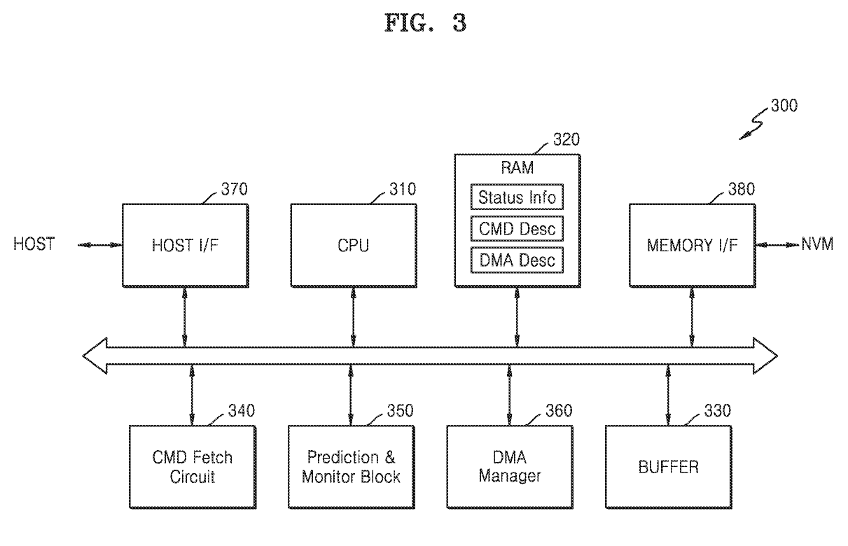

FIG. 3 is a block diagram of a controller 300 according to an example embodiment. The controller 300 may be an element included in a storage device such as an SSD or a memory card, and may be connected to a non-volatile memory NVM via a plurality of channels to control memory operations.

Referring to FIG. 3, the controller 300 may include a CPU 310, a RAM 320, a buffer 330, a command fetch circuit 340, a prediction and monitor block 350, a direct memory access (DMA) manager 360, a host interface 370, and a memory interface 380. Although a single CPU 310 is illustrated in FIG. 3, the controller 300 may include a plurality of CPUs as described above in relation to FIG. 2. The RAM 320 may store various types of information, e.g., the status information (Status Info) according to the afore-described example embodiment.

The controller 300 may communicate with a host via the host interface 370. For example, the command fetch circuit 340 may fetch commands from the host. In addition, the controller 300 may communicate with the non-volatile memory NVM via the memory interface 380. For example, write data and read data may be exchanged between the controller 300 and the non-volatile memory NVM via the memory interface 380. The write data from the host may be temporarily stored in the buffer 330 and then provided to the non-volatile memory NVM, and the read data read from the non-volatile memory NVM may be temporarily stored in the buffer 330 and then provided to the host.

The prediction and monitor block 350 may perform prediction and monitoring operations regarding the fetched commands. For example, the prediction and monitor block 350 may predict channels to be mapped to the fetched commands, among a plurality of channels connected to the non-volatile memory NVM. The channels mapped to the commands may refer to channels connected to a non-volatile memory device corresponding to physical addresses converted from logical addresses included in the commands.

In addition, the prediction and monitor block 350 may monitor statuses of the channels by checking the status information stored in the RAM 320. For example, when commands are fetched, the status information corresponding to channel information indicating the channels mapped to the commands may be read, and the fetched commands, and the channel information and the status information corresponding thereto may be stored to be accessible by the CPU 310. For example, the fetched commands may be stored in the RAM 320 in the form of descriptors (e.g., command descriptors CMD Desc) analyzable by the CPU 310. The channel information and the status information corresponding to the fetched commands may be included in and stored together with the command descriptors.

DMA descriptors (DMA Desc) including information about currently allocable storage spaces among a plurality of storage spaces in the buffer 330 may be further stored in the RAM 320. For example, the DMA descriptors may include information about addresses of validly allocable storage spaces of the buffer 330. The buffer 330 may be allocated for the commands with reference to the DMA descriptors.

Although the prediction and monitor block 350 is illustrated as a single functional block in FIG. 3, example embodiments are not limited thereto, and a circuit for performing prediction and a circuit for performing monitoring may be separately provided. The prediction and monitor block 350 of FIG. 3 may be implemented as hardware including, for example, a circuit. Alternatively, the prediction and monitor block 350 may be implemented as software including a plurality of programs, and stored in the controller 300 (e.g., in the RAM 320). Otherwise, the prediction and monitor block 350 may be implemented as a combination of hardware and software. Although the buffer 330 is included in the controller 300 in FIG. 3, the buffer 330 may be provided outside the controller 300 as described above in relation to FIGS. 1 and 2.

The DMA manager 360 may control direct memory access operations regarding the write data and the read data. For example, the DMA manager 360 may control operations of storing the write data from the host, in the buffer 330, and reading the write data from the buffer 330 to provide the same to the non-volatile memory NVM. In addition, the DMA manager 360 may control operations of storing the read data from the non-volatile memory NVM, in the buffer 330, and reading the read data stored in the buffer 330 to provide the same to the host.

An example of operation of the controller 300 illustrated in FIG. 3 is now described in detail.

A plurality of commands may be fetched from the host, and the prediction and monitor block 350 may predict channels mapped to the fetched commands. For the prediction operation, channel striping may be performed to evenly assign the commands to the channels. The channel striping operation may be performed using various schemes. For example, a plurality of channels may be sequentially mapped based on a command fetched order, or a channel may be mapped to each command through calculation using a logical address included in the command.

It is assumed that the controller 300 sequentially fetches first to N-th commands, and that the channel information and the status information corresponding to the fetched first to N-th commands are stored in the RAM 320.

To process the first to N-th commands, the CPU 310 may control buffer allocation by using various types of information stored in the RAM 320. For example, the status information corresponding to the earliest fetched first command may be checked. When the status information is set to a first value or a second value based on a workload of each channel, it may be determined whether allocation of the buffer 330 for the first command is appropriate, by checking the status information.

If a channel mapped to the first command has a large workload and thus the status information of the channel has the first value, it may be determined that allocation of the buffer 330 for the first command is not appropriate. Otherwise, if a channel mapped to the first command has a small workload and thus the status information of the channel has the second value, it may be determined that allocation of the buffer 330 for the first command is appropriate.

Similar to the above-described first command, the status information of a channel mapped to each of the second to N-th commands may be checked. Based on the result of checking, commands corresponding to the status information having the first value and commands corresponding to the status information having the second value may be determined.

The CPU 310 may select commands for which the buffer 330 is allocated, based on the result of checking the status information. For example, if the status information corresponding to the first command has the first value, allocation of the buffer 330 for the first command may be deferred. Otherwise, if the status information corresponding to the second command has the second value, the buffer 330 may be preferentially allocated for the second command compared to the first command. According to an example embodiment, the buffer 330 may be preferentially allocated for one or more of the first to N-th commands corresponding to the status information having the second value, and then allocated for the other commands corresponding to the status information having the first value.

That is, the CPU 310 preferentially allocates the buffer 330 for a command having an early processing timing or an early processing completion timing, irrespectively of a command fetched order. As such, a lifetime for which allocation of the buffer 330 is maintained may be reduced and thus usability of the buffer 330 may be improved. When usability of the buffer 330 is improved, the size of the buffer 330 may be reduced.

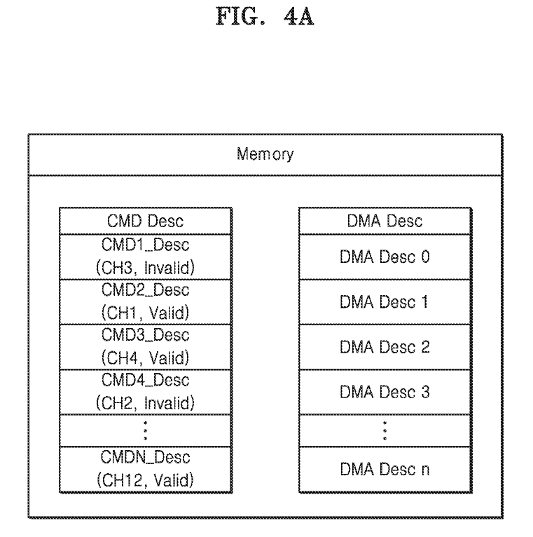

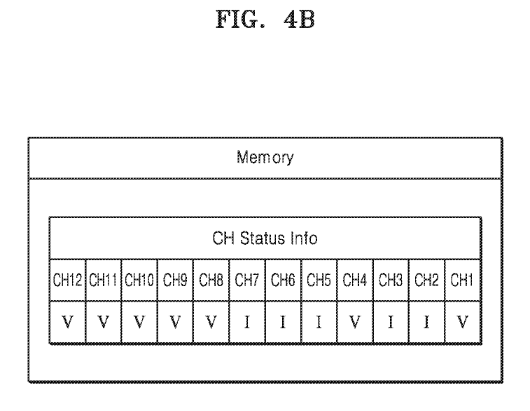

FIGS. 4A and 4B show information stored in the RAM 320 according to one or more example embodiments.

The RAM 320 may include various types of memories as described above. For example, the RAM 320 may be implemented as a volatile memory such as SRAM or DRAM. In addition, the RAM 320 may be implemented as a tightly coupled memory (TCM).

Referring to FIGS. 3 and 4A, when the command descriptors of the fetched commands are stored in the RAM 320, the channel information and the status information corresponding to the commands may also be stored therein based on the above-described prediction and monitoring operation. For example, assuming that the controller 300 is connected to the non-volatile memory NVM via twelve channels and that N commands CMD1 to CMDN are fetched from the host, the command descriptors of the N commands CMD1 to CMDN, and the channel information and the status information corresponding to the N commands CMD1 to CMDN are stored in the RAM 320. According to the afore-described example embodiment, the status information corresponding to each channel may have a first value I (invalid) or a second value V (valid). FIG. 4A shows an example in which the status information corresponding to a third channel CH3 mapped to the first command CMD1 has the first value I (invalid), and the status information corresponding to a first channel CH1 mapped to the second command CMD2 has the second value V (valid).

In addition, the DMA descriptors include information about storage spaces of the buffer 330 in which write data or read data is to be temporarily stored may be stored in the RAM 320. For example, the buffer 330 may include n storage spaces (n is an integer equal to or greater than 2), and the DMA descriptors may include address information of each storage space or information indicating whether each storage space is validly allocable for a command.

FIG. 4B shows an example in which the status information per channel is stored in the form of a table in the RAM 320. For example, the status information generated by determining a workload of each of twelve channels CH1 to CH12 may be stored, and a first value I (invalid) or a second value V (valid) may be stored to correspond to each channel. The status information shown in FIG. 4B may be read (or monitored) by the prediction and monitor block 350 according to the afore-described example embodiment.

The status information may be generated using various schemes. For example, the memory interface 380 may include command queues for queuing commands mapped to the channels CH1 to CH12, and a scheduler for scheduling execution of the commands stored in the command queues. The scheduler may determine a workload per channel based on the commands stored in the command queues corresponding to the channels CH1 to CH12, and generate and store the status information per channel in the RAM 320 based on the result of determination. For example, the scheduler may determine the workload per channel based on at least one of the number of unexecuted commands, the types of commands, and information indicating whether a background operation is performed.

Although the workload is determined using hardware by the scheduler in the above description, example embodiments are not limited thereto. For example, the operations of determining the workload per channel and generating the status information may be performed using software or using a combination of hardware and software.

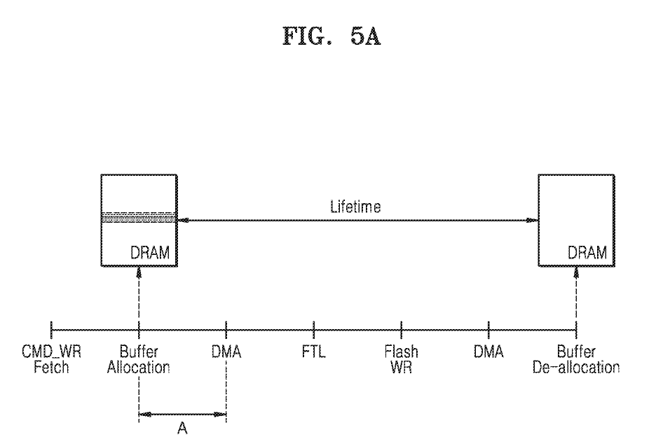

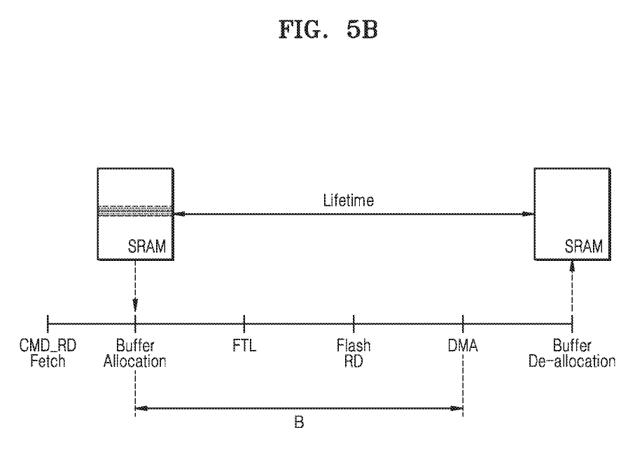

FIGS. 5A and 5B show lifetimes of a buffer in write and read operations of a non-volatile memory according to one or more example embodiments.

Referring to FIG. 5A, a plurality of commands stored in a buffer or a queue of a host may be fetched to a storage device (or a controller). For example, the commands may be fetched to the storage device based on an order of the commands stored in the host. FIG. 5A shows an example of processing any one write command CMD_WR.

Under the control of a processor core, e.g., a CPU, in the storage device, the write command CMD_WR may be fetched from the host. A buffer (e.g., DRAM) may be allocated for the fetched write command CMD_WR, and write data from the host may be stored in the buffer based on a DMA operation.

After the above-described operation is completed, the write data may be stored in a non-volatile memory under the control of the CPU. For example, a logical address corresponding to the fetched write command CMD_WR may be converted into a physical address by driving a flash translation layer (FTL). The physical address may correspond to a non-volatile memory connected to any one of a plurality of channels.

Thereafter, a flash write command Flash WR is provided as an internal command to the non-volatile memory for a write operation of the non-volatile memory, and the write data may be provided from the buffer to the non-volatile memory based on a DMA operation. After the write data is completely written in the non-volatile memory, the buffer may be de-allocated. In this case, a period between a timing when the buffer is allocated for the write command Flash WR and a timing when the buffer is de-allocated corresponds to a lifetime of the buffer allocated for the write command Flash WR.

If a prediction and monitoring operation is not used, the buffer is allocated at a timing when the write command Flash WR is fetched, and thus a period A between the timing when the buffer is allocated and a timing when the write data is stored in the buffer may be increased. For example, even when the buffer is allocated, because a processing timing of the write command Flash WR is late and thus the period A is increased, usability of the buffer is reduced.

Otherwise, if a prediction and monitoring operation according to an example embodiment is used, the buffer may be allocated at a later timing based on a status of a channel mapped to the write command Flash WR and thus the period A may be reduced. As such, usability of the buffer may be improved.

FIG. 5B shows an example in which a read command CMD_RD is fetched. A buffer (e.g., SRAM) may be allocated for the fetched read command CMD_RD, and a logical address corresponding to the fetched read command CMD_RD may be converted into a physical address by driving an FTL.

Thereafter, a flash read command Flash RD is provided as an internal command to a non-volatile memory for a read operation of the non-volatile memory. Data read from the non-volatile memory may be provided to a host via the buffer based on a DMA operation. After the read operation is completed, the buffer may be de-allocated. In this case, a period between a timing when the buffer is allocated for the read command Flash RD and a timing when the buffer is de-allocated corresponds to a lifetime of the buffer allocated for the read command Flash RD.

If a prediction and monitoring operation is not used, a period B between the timing when the buffer is allocated and a timing when the read data is stored in the buffer may be increased. Otherwise, if a prediction and monitoring operation according to an example embodiment is used, the buffer may be allocated at a later timing based on a status of a channel mapped to the read command Flash RD and thus the period B may be reduced.

Although the buffer is allocated after the read command Flash RD is fetched and before the FTL is driven in FIG. 5B, example embodiments are not limited thereto. For example, the buffer may be allocated at a timing corresponding to any one of various periods before the read data is stored in the buffer based on a DMA operation.

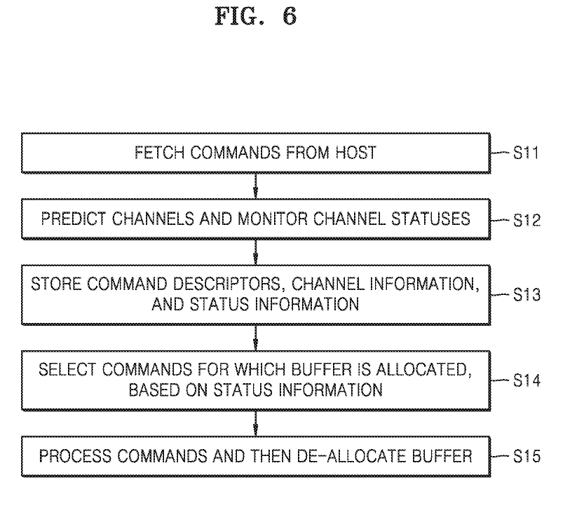

FIGS. 6 to 8 are flowcharts of operating methods of a storage device, according to one or more example embodiments.

Referring to FIG. 6, a storage device may fetch one or more commands from a host (S11). The fetched commands may be stored in a memory (e.g., RAM) in the form of command descriptors to be analyzable by a CPU.

Channels may be predicted for the fetched commands, and may be mapped to the commands based on the result of prediction. Statuses of the predicted channels may be monitored (S12). For example, the statuses of the channels may be monitored by accessing a memory for storing status information of a plurality of channels according to the afore-described example embodiments. According to an example embodiment, information indicating whether allocation of the buffer for the commands mapped to each channel is appropriate may be stored as the status information.

Based on the results of prediction and monitoring, command descriptors including channel information and the status information corresponding to the one or more fetched commands may be stored (S13), and the command descriptors, the channel information, and the status information may be analyzed by the CPU. Commands for which the buffer is allocated may be selected based on the status information under the control of the CPU (S14). For example, the buffer may not be allocated for the commands based on a command fetched order, but may be arbitrarily allocated for the commands based on the stored status information. The commands for which the buffer is allocated may be processed, and the buffer may be de-allocated after a data write or read operation is completed (S15).

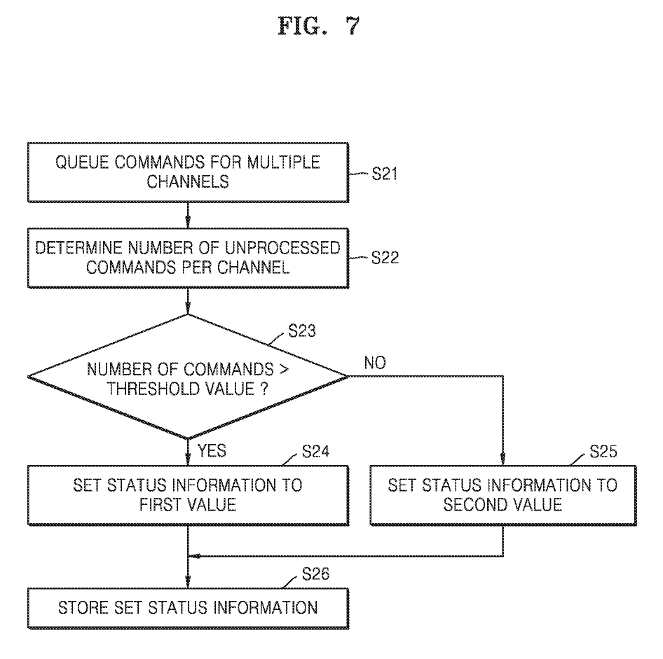

FIG. 7 shows an example of generating and storing status information.

Referring to FIG. 7, a storage device may include command queues for storing commands mapped to a plurality of channels, and a scheduler for scheduling operations of processing the commands stored in the command queues. The command queues may individually correspond to the channels, and thus command queuing may be performed per channel (S21).

The scheduler may determine workloads of the channels. For example, the scheduler may determine the number of unprocessed commands (or the number of commands remaining in a command queue) per channel (S22). According to an example embodiment, the scheduler may determine a workload per channel by checking commands stored in a command queue corresponding to each channel. For example, the scheduler may compare the number of commands to a certain threshold value to determine whether the number of commands is greater than the threshold value (S23).

Based on the result of comparison, status information corresponding to each of the channels may be generated, and the generated status information may be stored in a memory such as RAM. For example, if the number of commands mapped to a channel is greater than the threshold value, the status information of the channel may be set to a first value (S24). Otherwise, if the number of commands mapped to a channel is not greater than the threshold value, the status information of the channel may be set to a second value (S25).

The above-described operation of generating the status information based on the workload may be performed per channel, and the status information having the first or second value based on the result of comparison may be stored in the memory (S26).

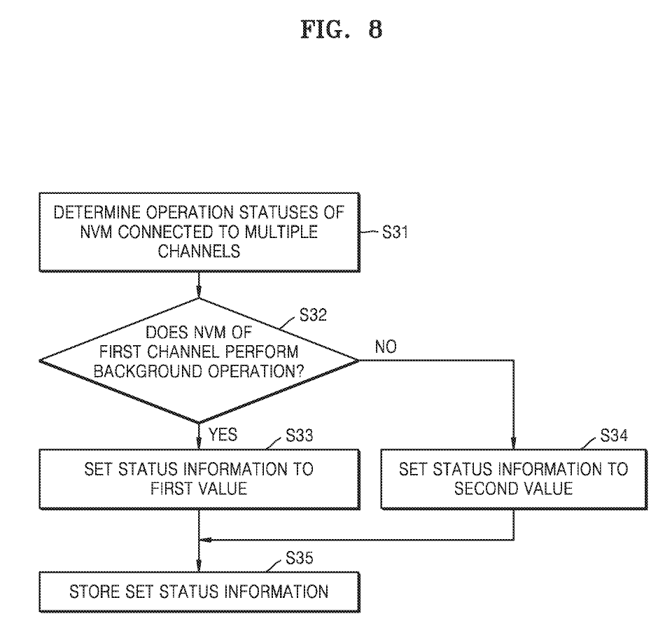

FIG. 8 shows another example of generating and storing status information.

Referring to FIG. 8, operation statuses of non-volatile memories connected to a plurality of channels may be determined (S31). For example, a scheduler included in a storage device may schedule various operations of the non-volatile memories connected to the channels. For example, the scheduler may schedule background operations of the non-volatile memories. The background operations may include various types of operations. For example, the background operations may include bad block management, garbage collection, data reclaim, and data replacement.

For example, one or more non-volatile memories may be connected to a first channel, and it may be determined whether at least one non-volatile memory of the first channel performs a background operation (S32). Specifically, the determination operation may be performed by determining whether the background operation is currently performed or is scheduled to be performed. Alternatively, the determination operation may be performed by checking commands (e.g., background operation commands) stored in a command queue corresponding to each channel.

Upon determining that at least one non-volatile memory connected to the first channel is performing the background operation, status information corresponding to the first channel may be set to a first value (S33). Otherwise, upon determining that the non-volatile memory is not performing the background operation, the status information corresponding to the first channel may be set to a second value (S34). The above-described operation of generating the status information based on whether the background operation is performed may be performed per channel, and the status information having a value set based on the result of determination may be stored in a memory (S35).

The operating methods illustrated in FIGS. 7 and 8 show example embodiments related to generation of the status information, and example embodiments may be variously changed. For example, the workload may be determined based on the types of commands queued per channel. For example, a write operation, a read operation, and an erase operation of a non-volatile memory may be performed at different speeds, and the status information may be set based on the types of commands queued per channel.

Alternatively, with regard to a background operation, the status information may be set based on whether the background operation is performed, or based on the type of the background operation (e.g., garbage collection or data reclaim).

A more detailed description is now given of example embodiments. The following description assumes that non-volatile memories NVM are flash memories and thus channels are flash channels. However, example embodiments may be applied to various types of non-volatile memories as described above.

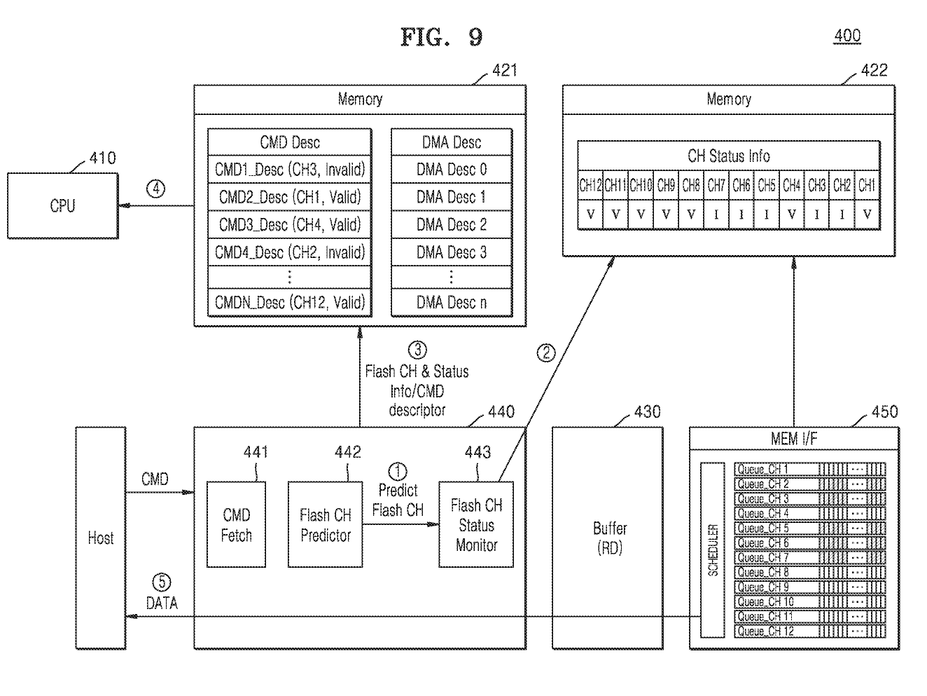

FIG. 9 is a block diagram showing flow of a buffer allocation operation according to an example embodiment. FIG. 9 shows a data read operation as an example of a memory operation.

Referring to FIG. 9, a controller 400 included in a storage device may include a CPU 410, one or more memories 421 and 422, a read buffer 430, a command information generation block 440, and a memory interface 450. The memories 421 and 422 may include a first memory 421 for storing command descriptors and DMA descriptors, and a second memory 422 for storing status information of a plurality of flash channels. According to the afore-described example embodiments, the command descriptors may include channel information and the status information corresponding to each command. Although FIG. 9 illustrates the first and second memories 421 and 422, the above-described information of various types may be stored in a single memory, or stored in a larger number of memories in a distributed fashion.

The command information generation block 440 is a block for functionally defining the configurations for performing the command fetch and prediction/monitoring operations according to the afore-described example embodiment, and the command information generation block 440 according to an example embodiment may be implemented as hardware. In this case, the command information generation block 440 may include a command fetch circuit 441 for fetching commands, a channel predictor circuit 442 for predicting a flash channel to be mapped to each command, and a channel status monitor circuit 443 for monitoring statuses of the flash channels. However, example embodiments are not limited thereto. At least a part of functions of the command information generation block 440 may be implemented by software, or the command information generation block 440 may be implemented as a combination of hardware and software.

Initially, commands (e.g., read commands) may be fetched, and the channel predictor circuit 442 may predict flash channels corresponding to the fetched commands by performing channel striping to evenly assign the commands to the flash channels, and provide the result of prediction to the channel status monitor circuit 443. The channel status monitor circuit 443 may monitor statuses corresponding to the predicted channels by checking the status information stored in the second memory 422. In addition, the command information generation block 440 may provide the predicted and monitored channel information and the status information to the first memory 421 together with the command descriptors of the fetched commands.

The CPU 410 may allocate a read buffer for the commands based on at least one of the command descriptors, the channel information, and the status information stored in the first memory 421. For example, the CPU 410 may allocate the buffer with reference to the status information stored in the first memory 421. A scheduler of the memory interface 450 may store the status information of the flash channels in the second memory 422 based on a workload of each channel according to the afore-described example embodiments. For example, the status information of second, third, and fifth to seventh flash channels CH2, CH3, and CH5 to CH7 may have a first value I indicating that buffer allocation is not appropriate.

The CPU 410 may determine commands corresponding to the status information stored in the first memory 421 and having a second value V, and preferentially allocate the buffer for the commands corresponding to the status information having the second value V. For example, the buffer may be sequentially allocated for the commands corresponding to the status information having the second value V. For example, the buffer may be preferentially allocated for the commands mapped to first, fourth, and eighth to twelfth flash channels CH1, CH4, and CH8 to CH12.

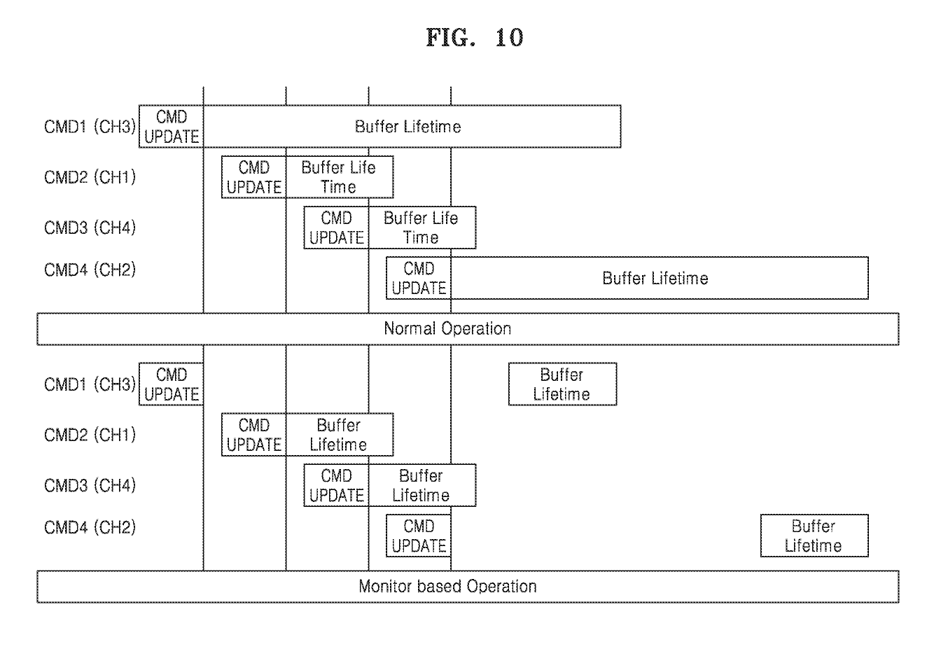

FIG. 10 shows an example of buffer lifetimes when a buffer allocation scheme according to example embodiments is used, and a case when the buffer allocation scheme is not used. FIG. 10 shows a case when first to fourth commands CMD1 to CMD4 are sequentially fetched. Because command descriptors of fetched commands are stored in a memory and thus a command descriptor list is updated, command fetching is indicated as command update CMD UPDATE. FIG. 10 shows an example in which the first command CMD1 is mapped to a third flash channel CH3, the second command CMD2 is mapped to a first flash channel CH1, the third command CMD3 is mapped to a fourth flash channel CH4, and the fourth command CMD4 is mapped to a second flash channel CH2. Similar to the afore-described example embodiment of FIG. 9, FIG. 10 shows an example in which status information of the second and third flash channels CH2 and CH3 has a first value I, and status information of the first and fourth flash channels CH1 and CH4 has a second value V.

In a normal operation, a buffer may be allocated based on a command fetched order at timings when the commands are fetched. As such, the buffer may be sequentially allocated for the first to fourth commands CMD1 to CMD4. In this case, the first command CMD1 mapped to the third channel CH3 is completely processed at a later timing, and the fourth command CMD4 mapped to the second channel CH2 is also completely processed at a later timing. As such, buffer lifetimes for the first and fourth commands CMD1 and CMD4 have large values, and thus usability of the buffer is reduced.

In a case when a buffer is allocated based on a result of monitoring status information of flash channels according to an example embodiment, the buffer may be allocated for the sequentially fetched first to fourth commands CMD1 to CMD4 irrespective of a command fetched order. For example, the buffer is preferentially allocated for the second and third commands CMD2 and CMD3 mapped to the first and fourth flash channels CH1 and CH4, the status information of which has the second value V. For example, the buffer is allocated for the second command CMD2, and then de-allocated after the second command CMD2 is completely processed at an early timing. Likewise, the buffer is allocated for the third command CMD3, and then de-allocated after the third command CMD3 is completely processed.

On the contrary, the buffer may be allocated later for the first and fourth commands CMD1 and CMD4. For example, because the buffer is allocated later for the first command CMD1 to be processed late, a buffer lifetime for the first command CMD1 may be reduced. Similar to the first command CMD1, a buffer lifetime for the fourth command CMD4 may also be reduced. That is, storage spaces of the buffer may be efficiently allocated for commands.

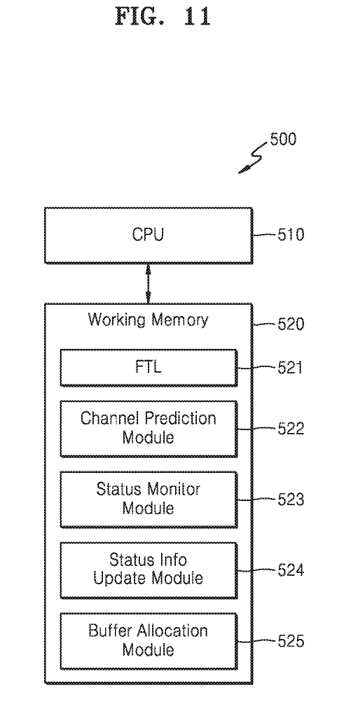

FIG. 11 is a block diagram showing an example in which a buffer allocation operation according to example embodiments is implemented by software.

Referring to FIG. 11, a controller 500 may include a CPU 510 and a working memory 520. Firmware for controlling operations of the controller 500 and memory operations of a non-volatile memory may be loaded in the working memory 520. An FTL 521 may be loaded in the working memory 520 as an example of the firmware, and the CPU 510 may drive the FTL 521 to perform various functions.

The FTL 521 may include modules for performing various functions. For example, the FTL 521 may include an address conversion module for converting a logical address from a host into a physical address indicating an actual storage location of the non-volatile memory. The FTL 521 may further include modules for performing various background functions of the non-volatile memory, e.g., a module for performing garbage collection, a module for managing bad blocks to prevent data from being written in the bad blocks, a module for performing data reclaim, and a module for performing data replacement.

For garbage collection, one or more free blocks may be generated. For example, the non-volatile memory may include a plurality of blocks, and each block may store valid data and invalid data which is not actually used by a user. The free blocks may be generated by moving valid data stored in one or more blocks, to other blocks, and erasing the blocks in which the valid data is not stored.

For bad block management, defective blocks among a plurality of blocks included in the non-volatile memory may be managed. For example, bad block management may be performed by checking a program/erase cycle of each of the blocks, and processing deteriorated blocks determined based on the result of checking, as bad blocks. Data may be prevented from being written in the blocks corresponding to the bad blocks.

Data reclaim and data replacement may be performed by determining deterioration of data. For example, data storage characteristics of non-volatile memory cells may deteriorate due to various reasons, e.g., leakage of trapped electrons or read disturb. A target of data reclaim or data replacement may be determined for each of the blocks included in the non-volatile memory. For example, when a specific block (e.g., a first block) is determined as a target of data replacement, valid data stored in the first block may be moved to a reserved block and the reserved block may be used as the first block. When a specific block (e.g., a first block) is determined as a target of data reclaim, valid data stored in the first block may be moved to another block and then the first block may be erased and reused.

Modules for performing the above-described functions according to example embodiments, e.g., a channel prediction module 522, a channel status monitor module 523, a status information update module 524, and a buffer allocation module 525, may be further loaded in the working memory 520. Although the above-described modules are loaded in the same working memory 520 in FIG. 11, the modules may be loaded in two or more memories in a distributed fashion.

The CPU 510 may drive various modules stored in the working memory 520 to perform the buffer allocation operation according to the afore-described example embodiments. For example, flash channels corresponding to fetched commands may be predicted by driving the channel prediction module 522, and statuses of a plurality of flash channels may be monitored by driving the channel status monitor module 523. Workloads of the flash channels may be determined by driving the status information update module 524, and status information having values based on the result of determination may be stored or updated in a memory. The CPU 510 may drive the buffer allocation module 525 to allocate a buffer based on the status information. For example, the buffer may be preferentially allocated for commands corresponding to the status information having a second value (e.g., a value indicating buffer allocation is appropriate) among a plurality of fetched commands irrespective of a command fetched order.

As described above, at least a part of functions of the various modules illustrated in FIG. 11 may also be implemented by hardware.

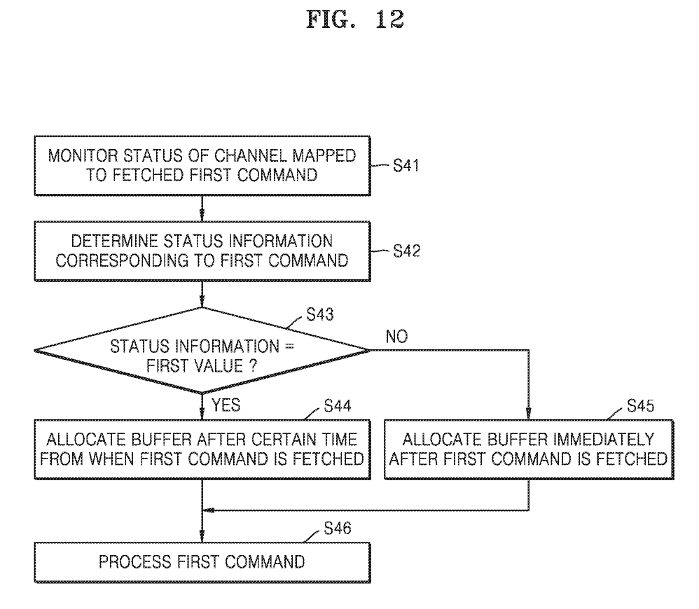

FIG. 12 is a flowchart of an operating method of a storage device, according to an example embodiment. Although FIG. 12 shows an example of processing a single command, example embodiments are not limited thereto.

Referring to FIG. 12, a first command is fetched from a host, and a status of a flash channel mapped to (or predicted for) the fetched first command is monitored (S41). Status information corresponding to the first command is checked by monitoring the status (S42), and thus it may be determined whether allocation of a buffer at present for the first command is appropriate.

It may be determined whether allocation of the buffer is appropriate, based on a value of the status information. For example, it may be determined whether the status information has a first value (S43). If the status information has the first value, this indicates that allocation of the buffer for the first command is not appropriate, and thus the buffer may be allocated for the first command after a certain time from when the first command is fetched (S44). Otherwise, if the status information has a second value, this indicates that allocation of the buffer for the first command is appropriate, and thus the buffer may be allocated for the first command immediately after the first command is fetched (S45). After the buffer is allocated for the first command as described above, the first command may be processed (S46).

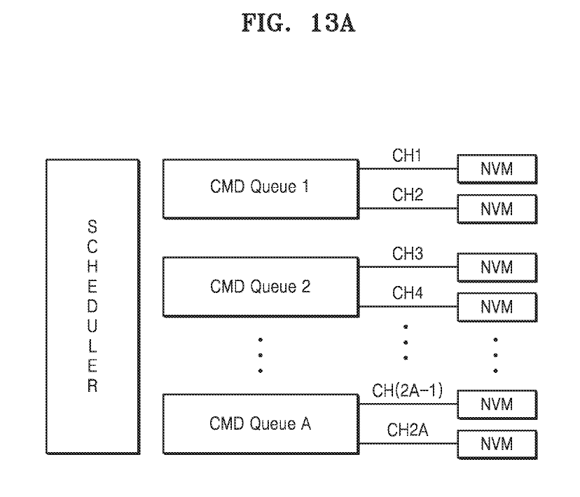

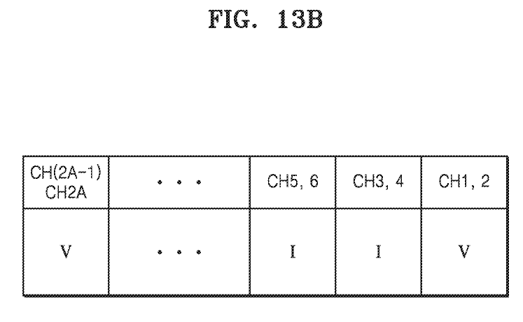

FIGS. 13A, 13B, 14A, 14B, 15A, 15B, 15C and 16 show various status information generation operations and a buffer allocation operations according to one or more example embodiments.

FIGS. 13A and 13B show an example of status information in a case when one command queue is provided to correspond to two or more channels. Although one command queue is provided to correspond to two channels in FIGS. 13A and 13B, example embodiments are not limited thereto, and one command queue may be provided to correspond to various numbers of channels.

Referring to FIG. 13A, a scheduler may queue a plurality of fetched commands in a plurality of command queues CMD Queue 1 to CMD Queue A. For example, A command queues CMD Queue 1 to CMD Queue A may be provided, and the commands may be provided to non-volatile memories NVM via 2*A channels CH1 to CH2A.

The scheduler may determine workloads of the channels CH1 to CH2A according to the afore-described example embodiments and generate status information based on the determined workloads. The workload may be determined using various schemes. For example, the workload may be determined based on the number of commands stored in each of the command queues CMD Queue 1 to CMD Queue A, or based on whether each non-volatile memory NVM performs or is scheduled to perform a background operation.

For example, because each of the command queues CMD Queue 1 to CMD Queue A is connected to two channels, a piece of status information may indicate a status of two channels. For example, as illustrated in FIG. 13B, if the number of commands stored in the second command queue CMD Queue 2 is greater than a certain number (or if the workload is greater than a threshold value), the status information of the third and fourth channels CH3 and CH4 connected to the second command queue CMD Queue 2 may be set to a first value I. Otherwise, if the number of commands stored in the A-th command queue CMD Queue A is not greater than the certain number (or if the workload is not greater than the threshold value), the status information of the (2A−1)-th and 2A-th channels CH(2A−1) and CH2A connected to the A-th command queue CMD Queue A may be set to a second value V. That is, a piece of status information may indicate a status of a plurality of channels.

To allocate a buffer for the commands based on the status information, the buffer may be preferentially allocated for the commands mapped to channels, the status information of which has the second value V. For example, the commands for which the buffer is allocated may be preferentially queued in the first and A-th command queues CMD Queue 1 and CMD Queue A, and then queued in the second command queue CMD Queue 2.

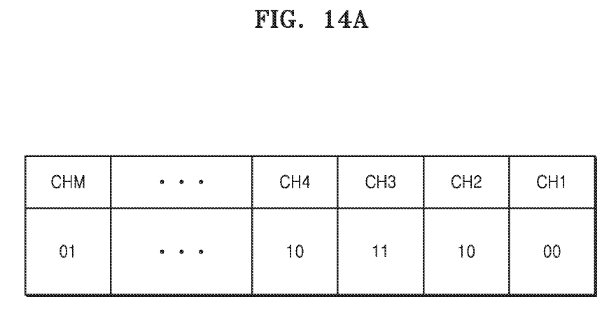

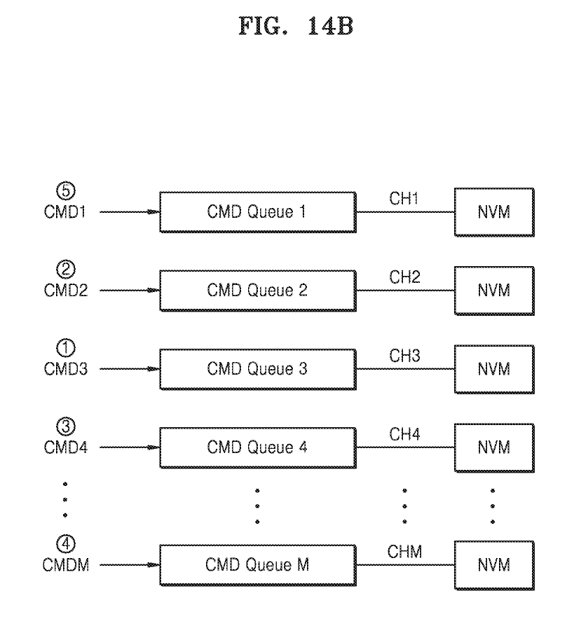

FIGS. 14A and 14B show a case in which status information includes two or more bits. The above-described workload may be determined in multiple stages. Bits having different values based on the determined stages may be generated as the status information. Although each piece of the status information includes two bits in FIGS. 14A and 14B, example embodiments are not limited thereto, and the status information may include one or more additional bits.

Referring to FIG. 14A, status information may be stored to correspond to each of a plurality of channels CH1 to CHM. The status information has two bits and thus may have any one value among 00, 01, 10, and 11. For example, status information corresponding to 00 may indicate the largest workload of a channel, and status information corresponding to 11 may indicate the smallest workload of a channel.

The multiple stages of the workload may be determined using various schemes. For example, a workload may be determined in multiple stages based on the number or types of commands stored in each of the command queues CMD Queue 1 to CMD Queue M, or based on whether each non-volatile memory NVM performs a background operation, and the type of the background operation. For example, the workload may be compared to two or more threshold values, and status information having a plurality of bits may be generated based on the result of comparison.

For example, the status information may have one of 00, 01, 10, and 11 based on the number of commands stored in each of the command queues CMD Queue 1 to CMD Queue M. Alternatively, the status information may have one of 00, 01, 10, and 11 based on the types of commands (e.g., read, write, and erase). Otherwise, the status information may be set to any one value based on the number and types of commands.

With regard to a background operation, if a non-volatile memory NVM connected to a specific channel performs or is scheduled to perform the background operation, it may be determined that the specific channel has the largest workload. The background operation may include various types of operations as described above, and the status information may have one of 00, 01, 10, and 11 based on the type of the background operation.

Various schemes other than the above-described schemes may be used to determine the status information in multiple stages.

Referring to FIG. 14B, an order of allocating a buffer for commands may vary based on the status information. For example, the command CMD3 for which the buffer is allocated may be preferentially queued in the command queue CMD Queue 3 connected to the third channel CH3 having the smallest workload. Thereafter, the buffer may be preferentially allocated for commands mapped to channels having small workloads based on the status information shown in FIG. 14A, and the commands may be stored in command queues corresponding thereto.

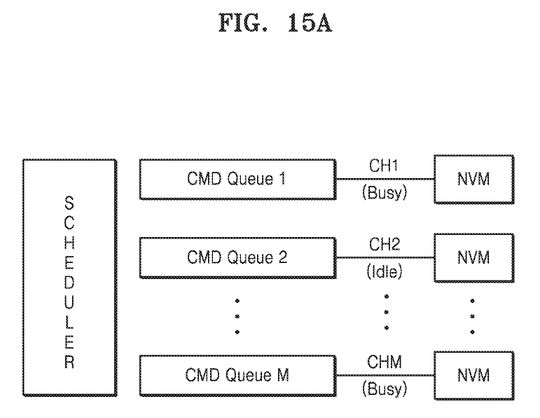

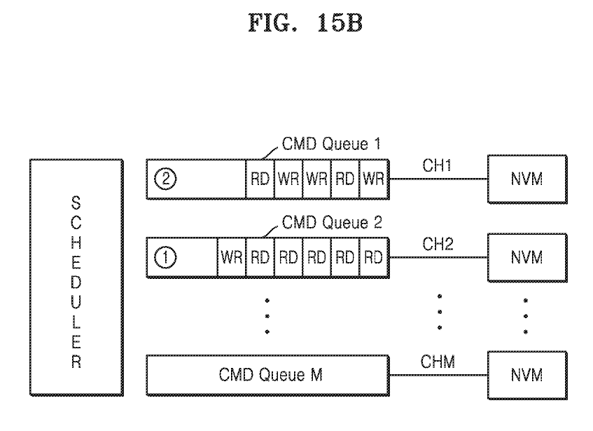

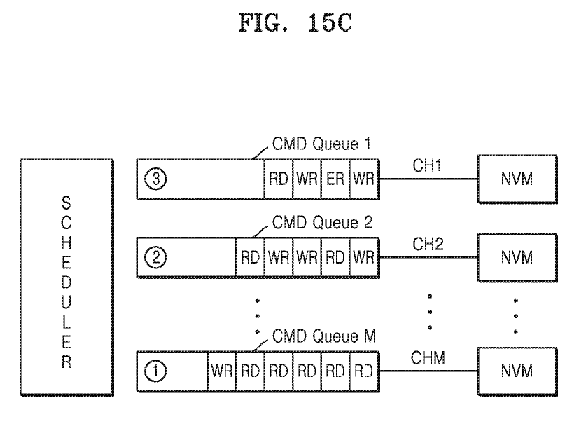

FIGS. 15A, 15B, and 15C show various other examples of determining a workload based on, for example, a busy/idle status of each channel, the types of commands, and background operations.

Referring to FIG. 15A, a scheduler may determine busy and idle statuses of a plurality of channels CH1 to CHM, and status information may be generated based on the determined busy and idle statuses. For example, when commands are fully queued in a command queue, a channel connected to the command queue may be determined to a busy status. As such, commands for which a buffer is allocated may be preferentially queued in a command queue connected to a channel determined to an idle status. For example, if the first channel CH1 is in a busy status and the second channel CH2 is in an idle status, even when commands mapped to the first channel CH1 are fetched earlier, the buffer may be preferentially allocated for commands mapped to the second channel CH2.

Referring to FIG. 15B, a larger number of commands may be stored in the second command queue CMD Queue 2 compared to the first command queue CMD Queue 1. In this case, workloads of the first and second channels CH1 and CH2 may be determined based on the types of commands stored in the first and second command queues CMD Queue 1 and CMD Queue 2, respectively. For example, the types of commands may include write, read, and erase, and a relatively long time may be taken to process an erase command while a relative short time may be taken to process a read command.

FIG. 15B shows write commands WR and read commands RD. Although the second command queue CMD Queue 2 stores a larger number of commands compared to the first command queue CMD Queue 1, the first channel CH1 connected to the first command queue CMD Queue 1 may be determined to have a greater workload. For example, because a longer time is taken to process a write command WR, the workload may be determined by giving a weight to the write commands WR. As such, even when commands mapped to the first channel CH1 are fetched earlier, the buffer may be preferentially allocated for commands mapped to the second channel CH2.

FIG. 15C shows write commands WR, read commands RD, and an erase command ER, and the longest time may be taken to process an erase command ER. Similar to the afore-described example embodiment, different weights may be given to different types of commands, and workloads of the channels CH1 to CHM may be determined based on the result of giving weights.

In FIG. 15C, the smallest number of commands may be stored in the first command queue CMD Queue 1, and the largest number of commands may be stored in the M-th command queue CMD Queue M. However, as described above, the first channel CH1 connected to the first command queue CMD Queue 1 in which the erase command ER is stored may be determined to have the largest workload, and the M-th channel CHM connected to the M-th command queue CMD Queue M in which smaller numbers of write commands WR and erase commands ER are stored may be determined to have the smallest workload. The buffer may be allocated for commands based on the workloads determined as described above.

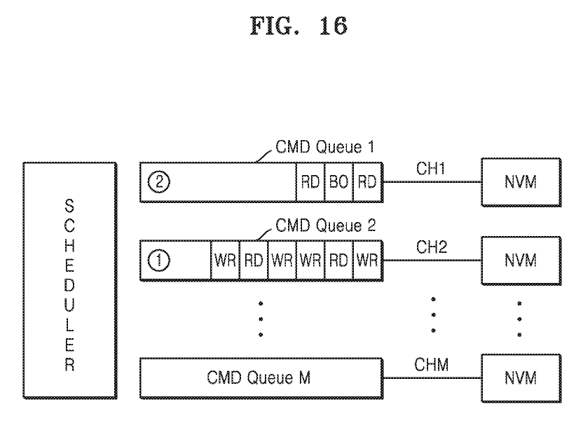

FIG. 16 shows a case in which background operation commands are stored in a command queue and thus background operations are scheduled.

Referring to FIG. 16, a smaller number of commands may be stored in a first command queue CMD Queue 1, and a larger number of commands may be stored in a second command queue CMD Queue 2. In addition, one or more background operation commands BO may be stored in the first command queue CMD Queue 1.

In this case, a first channel CH1 connected to the first command queue CMD Queue 1 may be determined to have a larger workload compared to the workload of a second channel CH2 connected to the second command queue CMD Queue 2, by giving the largest weight to the background operation commands BO similarly to the afore-described example embodiment. Alternatively, a channel scheduled to perform background operations may always be determined to have a larger workload compared to a channel not scheduled to perform background operations. Otherwise, when two or more channels are scheduled to perform background operations, a channel having a larger workload may be determined based on the numbers of the background operation commands BO.

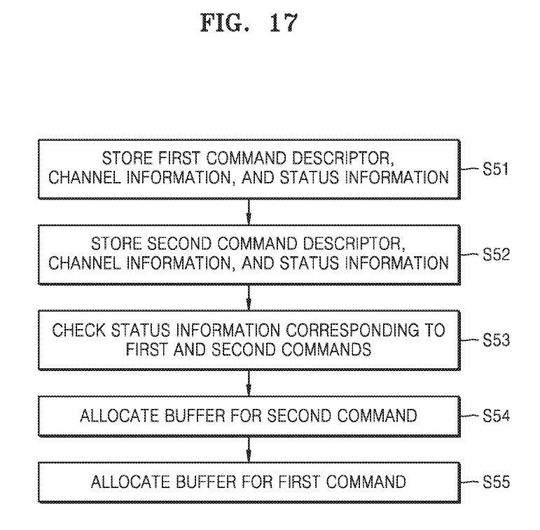

FIG. 17 is a flowchart of an operating method of a storage device, according to an example embodiment. Although FIG. 17 shows an example of processing sequentially fetched first and second commands, example embodiments are not limited thereto.

Referring to FIG. 17, the first command is fetched and thus a command descriptor, channel information and status information corresponding to the first command are stored to be accessible by a CPU (S51). Thereafter, the second command is fetched, and a command descriptor, channel information and status information corresponding to the second command are stored to be accessible by the CPU (S52).

The CPU may check the status information corresponding to the first and second commands (S53), and control a buffer allocation operation based on the result of checking. For example, when the status information corresponding to the first command has a first value and the status information corresponding to the second command has a second value, the CPU preferentially allocates a buffer for the late fetched second command (S54). After the buffer is allocated for the second command, the CPU may allocate the buffer for the earlier fetched first command (S55).

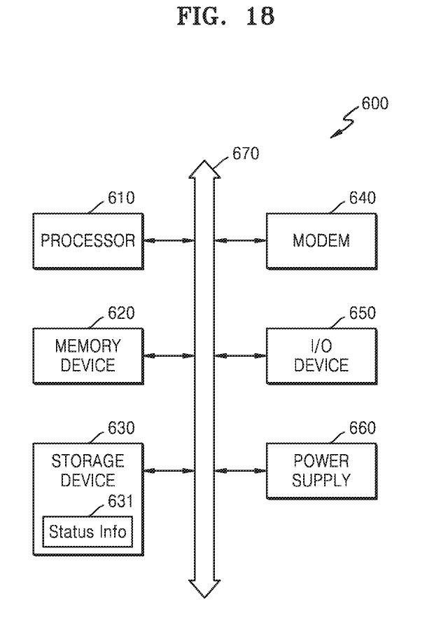

FIG. 18 is a block diagram of an electronic system 600 according to an example embodiment.

Referring to FIG. 18, the electronic system 600 may include a processor 610, a memory device 620, a storage device 630, a modem 640, an input/output (I/O) device 650, and a power supply 660. In the current example embodiment, the storage device 630 may be a storage device according to any one of the afore-described example embodiments. As such, the storage device 630 may include a memory 631 for storing status information per channel. The storage device 630 may fetch commands, predict channels for the fetched commands, monitor channel statuses by checking the memory 631, and allocate a buffer based on the result of monitoring irrespective of a command fetched order.

In a controller, a storage device, and an operating method of the storage device according to example embodiments, because a buffer is allocated for commands by monitoring statuses of a plurality of flash channels, unnecessary occupation of the buffer may be reduced and thus usability of the buffer may be improved.

In addition, due to improved usability of the buffer, the size of a high-price memory, e.g., SRAM or DRAM, included in the storage device may be reduced.

While example embodiments have been particularly shown and described, it will be understood that various changes in form and details may be made therein without departing from the spirit and scope of the following claims.

1. A storage device comprising:
a non-volatile memory comprising a plurality of non-volatile memory cells;
a buffer comprising a plurality of storage spaces to be allocated for a plurality of commands fetched from a host; and
a storage controller connected to the non-volatile memory via a plurality of channels, the storage controller being configured to store status information corresponding to a workload of each of the plurality of channels and to allocate the buffer for the plurality of commands based on the status information.

2. The storage device of claim 1, wherein the storage controller is further configured to allocate the buffer irrespective of a command fetched order.

3. The storage device of claim 1, wherein the storage controller comprises a plurality of command queues corresponding to the plurality of channels, and
wherein the workload of each of the plurality of channels is determined based on a corresponding number of commands stored in each of the plurality of command queues.

4. The storage device of claim 1, wherein the storage controller is further configured to compare the workload of each of the plurality of channels with a threshold value, and generate the status information corresponding to the workload of each of the plurality of channels indicating one among a first value and a second value based on a result of the comparing.

5. The storage device of claim 1, wherein the storage controller is further configured to sequentially fetch a first command mapped to a first channel of the plurality of channels and a second command mapped to a second channel of the plurality of channels, and preferentially allocate the buffer for the second command based on the status information to queue the second command in a command queue.

6. The storage device of claim 1, wherein the storage controller comprises a prediction and monitor block configured to predict channels to be mapped to the plurality of commands based on channel striping, and monitor statuses of the channels that are mapped based on the status information.

7. The storage device of claim 6, further comprising a memory for configured to receive command descriptors of the plurality of commands, channel information of the plurality of channels from the prediction and monitor block, and the status information corresponding to the workload of each of the plurality of channels from the prediction and monitor block, and store the command descriptors of the plurality of commands, the channel information of the plurality of channels from the prediction and monitor block, and the status information corresponding to the workload of each of the plurality of channels.

8. The storage device of claim 1, wherein the workload of each of the plurality of channels is determined based on whether a corresponding non-volatile memory cell is performing a background operation.

9. The storage device of claim 8, wherein the storage controller is further configured to determine whether the corresponding non-volatile memory cell of the plurality of non-volatile memory cells is currently performing or is scheduled to perform the background operation, and generate the status information corresponding to the workload of each of the plurality of channels as one among a first value and a second value based on whether the corresponding non-volatile memory cell of the plurality of non-volatile memory cells is currently performing or is scheduled to perform the background operation.

10. The storage device of claim 1, wherein the storage controller is further configured to fetch a first command mapped to a first channel of the plurality of channels and allocate a storage space of the plurality of storage spaces in the buffer for the first command based on the status information corresponding to the first command after a certain time from a timing when the first command is fetched.

11. The storage device of claim 1, wherein the status information corresponding to the workload of each of the plurality of channels is determined in multiple stages and comprises a plurality of bits, and
wherein the storage controller is further configured to allocate the buffer in an order from a first command mapped to a first channel having a small workload to a second command mapped to a second channel having a large workload.

12. The storage device of claim 1, wherein the storage controller comprises a plurality of command queues, each of the plurality of command queues being connected to at least two channels of the plurality of channels, and
wherein the status information corresponding to the workload of each of the plurality of channels is generated based on commands stored in each of the plurality of command queues.

13. A storage controller configured to control a non-volatile memory via a plurality of channels, the storage controller comprising:
a central processing unit (CPU);
a fetch circuit configured to fetch a plurality of commands from a host;
a memory configured to store status information corresponding to a workload of each of the plurality of channels;
a prediction and monitor block configured to predict channels of the plurality of channels to be mapped to the plurality of commands, and monitor statuses of the channels as predicted based on the status information; and
a buffer comprising a plurality of storage spaces to be allocated for the plurality of commands based on a result of monitoring.

14. The storage controller of claim 13, further comprising a memory interface comprising:
a plurality of command queues configured to store commands mapped to the plurality of channels; and
a scheduler configured to generate the status information based on a number of commands stored in each of the plurality of command queues.

15. The storage controller of claim 13, further comprising a memory interface configured to control the non-volatile memory via the plurality of channels, determine whether the non-volatile memory currently performs or is scheduled to perform a background operation, and generate the status information based on whether the non-volatile memory currently performs or is scheduled to perform the background operation.

16. The storage controller of claim 15, wherein the background operation comprises at least one among garbage collection, bad block management, data reclaim, and data replacement.

17. The storage controller of claim 13, wherein the status information is set to a first value if the workload of a corresponding channel is greater than a threshold value, and a second value if the workload of the corresponding channel is not greater than the threshold value.

18. The storage controller of claim 17, wherein the plurality of commands comprises sequentially fetched first to N-th commands, and
wherein the buffer is preferentially allocated for one or more of the first to N-th commands mapped to a channel of which the status information has the second value.

19. The storage controller of claim 13, wherein the prediction and monitor block comprises:
a predictor circuit configured to predict the channels of the plurality of channels to be mapped to the plurality of commands; and
a monitor circuit configured to read the status information stored in the memory.

20. The storage controller of claim 13, wherein the prediction and monitor block comprises programs executable by the CPU to predict the channels and read the status information.

21-29. (canceled)
